(19) United States
(12) Patent Application Publication
(10) Pub. No.: US 2009/0307035 A1
(43) Pub. Date: Dec. 10, 2009

(54) RESOLUTION OF RESOURCE OVER-ALLOCATIONS IN PROJECT PLANS

(75) Inventors: Alice Steinglass, Redmond, WA (US); Bonny Lau, Bellevue, WA (US); Raju Iyer, Newcastle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/132,629

(22) Filed: Jun. 4, 2008

(51) Int. Cl. G06Q 10/00

(52) U.S. Cl. 705/8

(57) ABSTRACT

Architecture that introduces a new default leveling algorithm related to a leveling order that uses one or more of task identifier, start dates, and existing priority field, such that users do not need to define an explicit priority value for each task before using leveling. The architecture allows the user to reschedule only a specific task based on availability, without changing other tasks in the schedule. Users can select a single over-allocated task and the architecture looks at all other tasks in the overall schedule to find the next open timeslot when the assigned resources have capacity. The architecture further allows a user to selectively level a subset of tasks in a project. The user can choose to level only tasks that are relevant and the application only resolves over-allocation within the selection and excludes all other unselected tasks in the project.

### BACKGROUND

The resource leveling functionality in project applications helps users resolve over-allocation in project plans. The application reschedules incomplete work where resources are working on multiple assignments and are over the maximum capacity. To make use of this feature, users need to define a priority value for each task in a project to indicate the importance of tasks. The application then attempts to move lower priority tasks in preference for higher priority tasks.

However, there are limitations to this feature. For this feature to reschedule tasks in a predictable manner, users must first define priority field values for all the tasks. Many users are unaware of how this field is used, and thus, leveling will reschedule tasks in an unpredictable manner.

For example, consider a list of tasks assigned to a user, each having a default priority value set. If the user does not change these values, the leveling algorithm will reschedule these tasks in a seemingly random order. Even after the priority value is defined, which can be a lengthy process for a large project, it is difficult for the user to manage and keep track of these priority values. If the user wants to add a new task to the project, the user may have to redefine the priority of a large number of tasks to fit the new task in the right order. In other words, users are limited to leveling either the entire project or all tasks within a specific date range. Each time leveling is executed, a large number of tasks can be shuffled around and there is no easy way for the users to step through a schedule and resolve over-allocation on an individual basis.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture introduces a new default leveling algorithm related to order that uses a combination of task identifier and start dates, in addition to an existing priority field, such that users do not need to define an explicit priority value for each task before using leveling. The architecture allows the user to reschedule only a specific task based on availability, without changing other tasks in the schedule. Users can select a single over-allocated task and the architecture looks at all other tasks in the overall schedule to find the next open timeslot when the assigned resources have capacity.

The architecture further allows a user to selectively level a subset of tasks in a project. The user can choose to level only tasks that are relevant and the application only resolves over-allocation within the selection and excludes all other unselected tasks in the project.

To the accomplishment of the foregoing and related ends, certain illustrative aspects are described herein in connection with the following description and the annexed drawings. These aspects are indicative of the various ways in which the principles disclosed herein can be practiced, all aspects and equivalents of which are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented resource leveling system.

FIG. 2 illustrates an alternative system for leveling an over-allocated resource using a leveling order.

FIG. 3 illustrates the rescheduling of selected tasks to a next available timeslot of an assigned resource.

FIG. 4 illustrates functionality for limiting leveling to a subset of tasks.

FIG. 5 illustrates a method of processing resources.

FIG. 6 illustrates a method of invoking a leveling order.

FIG. 7 illustrates the implementation of leveling order based on priority data.

FIG. 8 illustrates the implementation of leveling order based on start date.

FIG. 9 illustrates the implementation of leveling order based on task ID.

FIG. 10 illustrates a block diagram of a computing system operable to execute resource allocations in accordance with the disclosed architecture.

### DETAILED DESCRIPTION

The disclosed architecture introduces a new default leveling order that uses a combination of task identifier (ID) and task start date both of which implicitly indicate a user preference for task sequences, in addition to the existing explicitly defined priority. This reduces the amount of configuration and maintenance work otherwise required from the user to make use of leveling. The user can also reschedule an over-allocated task based on resource availability and workload without affecting the dates of their other assignments. Additionally, users can resolve over-allocation for a subset of tasks in a project, such that the unselected tasks are completely excluded from the availability calculation.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

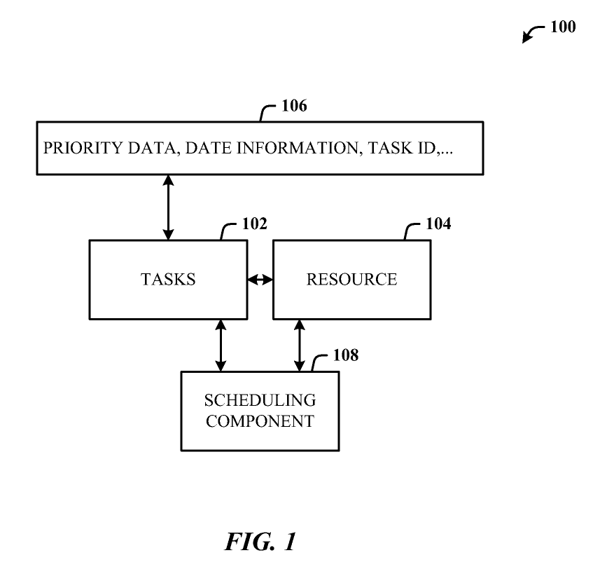

FIG. 1 illustrates a computer-implemented resource leveling system 100. The system 100 includes a set of tasks 102 assigned to an over-allocated resource 104 for completion, each of the tasks 102 associated with priority data, date information, and a task identifier (ID), etc., 106. The system 100 can also include a scheduling component 108 for rescheduling the tasks 102 to the over-allocated resource 104 based on one or more of the priority data, the date information, and the task identifier 106.

The scheduling component 108 facilitates selection of a subset of the tasks 102 for rescheduling and excludes unselected tasks from a resource availability calculation. The scheduling component 108 reschedules a task assigned to the over-allocated resource without changing date information of other scheduled tasks. The scheduling component 108 reschedules a task assigned to the over-allocated resource 104 to a next available timeslot in which the over-allocated resource 104 can work on the task, and considers all tasks 102 when searching for the next available timeslot for the task. Moreover, the scheduling component 108 reschedules a task independent of whether associated priority data is explicitly defined.

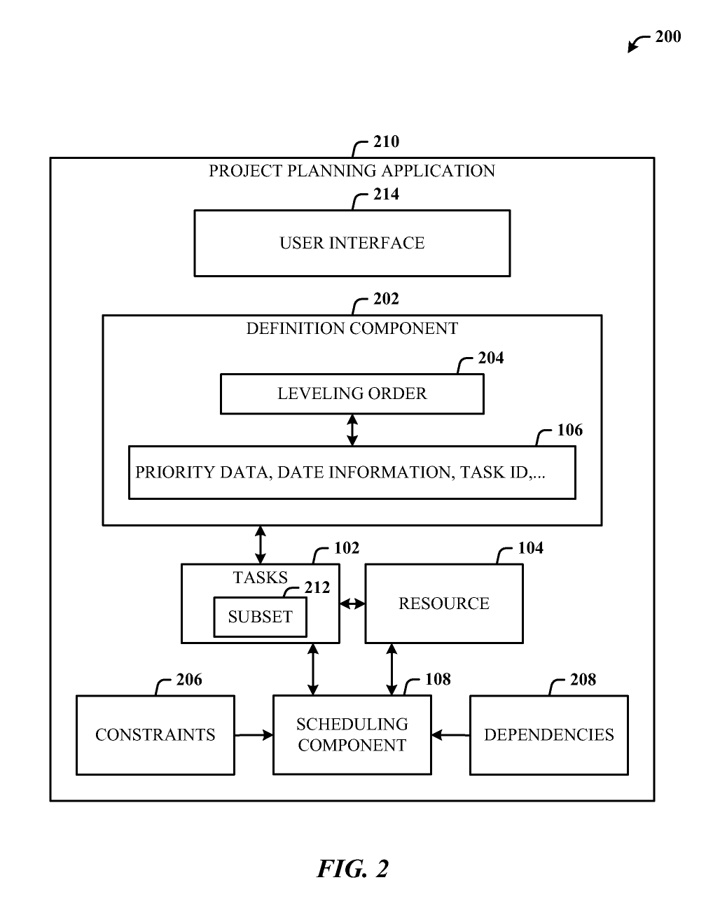

FIG. 2 illustrates an alternative system 200 for leveling an over-allocated resource using a leveling order. The system 200 includes the entities (e.g., tasks 102, resource 104, priority data, date information, task identifier, . . . 106 and scheduling component 108 of FIG. 1, and a definition component 202 for defining a leveling order 204 for which a task is rescheduled. The leveling order 204 can be defined according to any single task property or combination of task properties, where a task property can be priority data, date information, task ID, and so on. In one implementation, the leveling order 204 is comprised solely of the priority data, date information, task ID. In a yet more specific implementation, the leveling order 204 first considers the task priority data, followed by the priority data and date information, and lastly, the combination of the priority data, date information and task ID. Additionally, the scheduling component 108 can reschedule the tasks based on the leveling order 204, while respecting constraints 206 and dependencies 208.

The system 200 is shown as being applied in a project planning application 210; however, it is to appreciated that the disclosed architecture is not so limited, but can be applied to other applications, programs, etc., where task and resource scheduling are employed.

In other words, the system 200 can include tasks 102 assigned to the resource 104 (e.g., over-allocated) for completion, where each task is associated with priority data, date information, and a task identifier 106. The scheduling component 108 reschedules the tasks 102 to the resource 104 based on a leveling order 204 defined according the priority data, the date information, and the task ID 106, while respecting the constraints 206 and dependencies 208.

The scheduling component 108 further facilitates the selection of a subset 212 of the tasks 102 for rescheduling and excludes unselected tasks from the rescheduling of the subset 212. The scheduling component 108 can reschedule a task assigned to the resource 104 without changing start date information of other scheduled tasks. Moreover, the scheduling component 108 can reschedule a task assigned to the resource 104 to a next available timeslot in which the resource 104 can work on the task, and select the next available timeslot in consideration of all remaining (or other) tasks 102. A user interface 214 can be provided for the project planning application 210 that facilitates interaction with functionality of the scheduling component 108 to reschedule to a next available timeslot and to level a selected set of the tasks 102 (e.g., the subset 212).

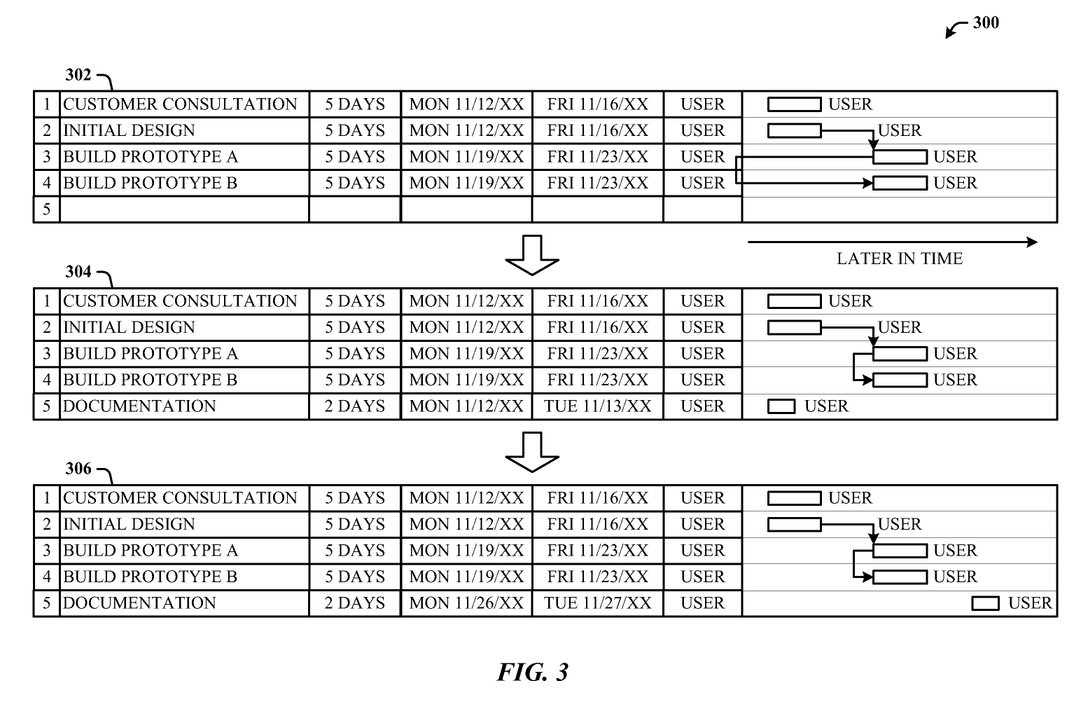

FIG. 3 illustrates the rescheduling of selected tasks to a next available timeslot of an assigned resource. The “Reschedule to Next Available” functionality is made available as a menu button in the user interface. When invoked, the algorithm evaluates the current selection of tasks and, if any of the resources assigned to those tasks are over-allocated, the scheduling algorithm (scheduling component 108) looks for the next timeslot in which the resources can have the capacity to work on the task. While the algorithm takes all tasks in the project into account when searching for available timeslots, the algorithm only reschedules the selected tasks. Any unselected tasks will remain undisturbed.

The “next available” functionality is illustrated in a series of resource panels 300. In a first task panel 302, a resource called User has been scheduled initially for a number of tasks by a project manager. User is initially scheduled to complete overlapping tasks 1 and 2 in parallel, and thereafter, tasks 3 and 4 in parallel.

In a second resource panel 304, the project manager adds a new task “Documentation” to the plan and assigns it to User. User, however, is already overbooked and is unable to work on this new task in parallel with all other tasks (tasks 1, 2, 3 and 4).

In accordance with the selective functionality provided herein, the project manager can select the task that desired for rescheduling (e.g., the Documentation task 5) by clicking on a “Reschedule to Next Available” button, for example. The application then looks at all tasks within this project, and searches for a timeslot (new date) when resource User is not working beyond maximum capacity. The algorithm then moves the task to that new date. All other tasks (tasks 1, 2, 3 and 4) are unaffected. The resulting allocation is shown in a third resource panel 306.

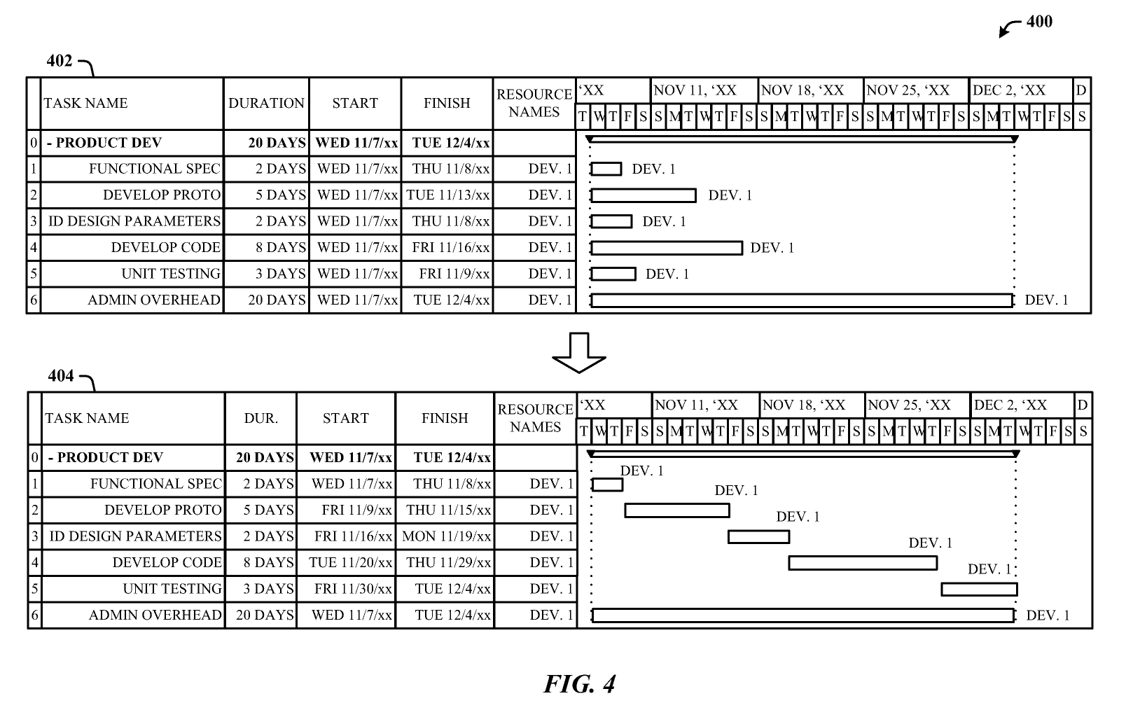

FIG. 4 illustrates functionality for limiting leveling to a subset of tasks. The “level selection” functionality is illustrated by way of resource panels 400. This functionality can be made available as a menu button in the user interface. When invoked, the algorithm generates a task rowset that includes all tasks in User's current selection. Leveling reschedules and resolves over-allocation only within this selection of tasks. All other tasks that are not included will be excluded from consideration when leveling calculates resource workload and availability.

As shown in the illustrated first project resource panel 402, a resource “Developer 1” (also DEV. 1) has a number of tasks assigned that are currently scheduled to occur in parallel. The project manager wants to resolve the over-allocation such that the resource is only working on a single task at a time, with the exception of the last task “Administrative Overhead”, which the resource will work on in parallel with other tasks.

The project manager can select the first five tasks (task IDs 1-5) and execute the “Level Selection” functionality. The application then automatically reschedules the five tasks such that there is no over-allocation among the selections as shown in a second project resource panel 404. The last task, “Administrative Overhead”, is excluded from consideration by the algorithm and will remain unchanged, since it was not selected. The result is that resource “Developer 1” will only be working on one of the first five tasks together with the task “Administrative Overhead”, rather than all five tasks and the task “Administrative Overhead” shown in the first panel 402.

Included herein are flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

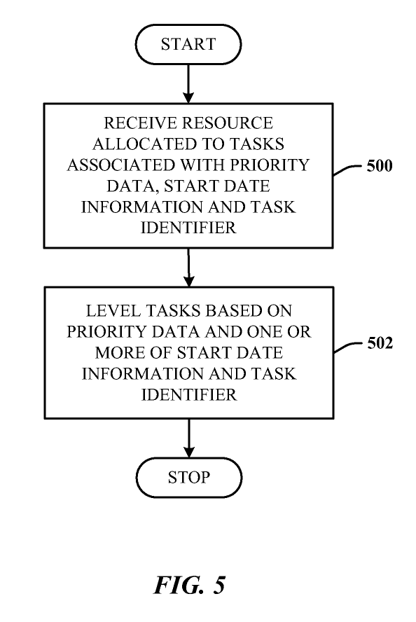

FIG. 5 illustrates a method of processing resources. At 500, a resource allocated to tasks is received. The tasks are associated with priority data, start date information, and a task identifier. At 502, the tasks are leveled based on the priority data and one or more of the start date information and a task identifier. The priority data, start date information and the task identifier are processed according to a leveling order.

The method can further comprise processing constraints and dependencies as part of the leveling of the tasks. The method can further comprise scheduling a new task assigned to the resource in a next available timeslot, and processing all tasks when computing the next available timeslot. The tasks can be a subset of a larger set of tasks allocated to the resource. The tasks can be selected and leveled without impacting a start date of unselected tasks of the larger set of tasks. The method can further comprise rescheduling the tasks bases on an ascending order of importance where less important tasks are delayed before more important tasks.

The leveling order can use a combination of task ID, task start date and priority, and other properties, if desired. When the leveling algorithm reschedules tasks in a project, the algorithm moves tasks in an ascending order of importance. This means that tasks that are deemed less critical are delayed first, and more important tasks are delayed as little as possible. Tasks are moved until all resource over-allocation that can possibly be resolved is resolved, while constraints and dependencies are still respected. This results in a schedule where more important tasks will happen first, before the less important tasks.

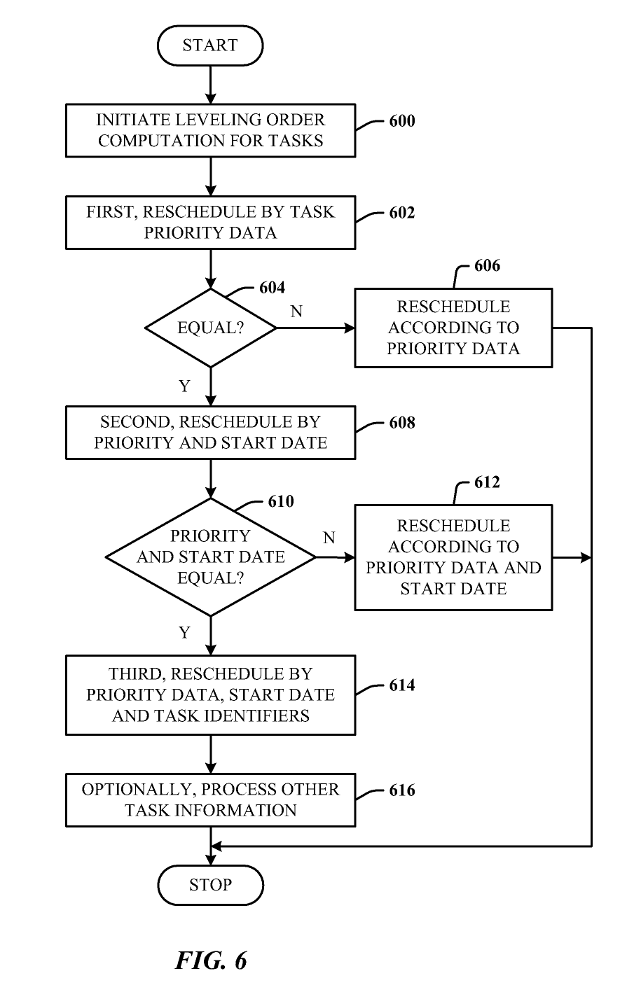

FIG. 6 illustrates a method of invoking a leveling order. In one implementation, the disclosed architecture employs a combination of factors to determine the leveling order: priority, start date, and task ID. At 600, leveling order computation is initiated. At 602, first reschedule by task priority data. If the user had explicitly defined priority values, the algorithm will still respect these values and use these values as the foremost factor for determining which task to move first. At 604, if the tasks priorities are not equal, flow is to 606, to then reschedule according to the priority data.

Alternatively, if the tasks priorities are not equal, at 604, rescheduling is performed according to the priority data and the start date, as indicated at 608. In other words, between two tasks that have equal priority, if one of the tasks has an earlier start date than the other task, leveling will try to move the other task, thereby maintaining the task sequence. A task that is scheduled to happen earlier than another task will still happen earlier, after leveling.

If the priority data and start date are not equal, as checked at 610, flow is to 612 to then reschedule the task according to both the priority data and the start date. If, however, the priority data and start date are equal, as checked at 610, flow is to 614 to reschedule the task by the priority data, start date and task IDs. At 616, optionally, other task information (properties) can be considered. In other words, between two tasks that have equal priority and task start date, the algorithm will try to move the task with a bigger ID before moving the task with the smaller ID. Generally, when project managers create a task list, the managers tend to enter items in an implicit, chronological order. Items that are higher up on the list (smaller ID numbers) are to happen before items that are further down the list (bigger ID). Hence, the algorithm tries to reschedule items that are lower down on the list to resolve over-allocation before the algorithm tries to reschedule an item higher up on the list.

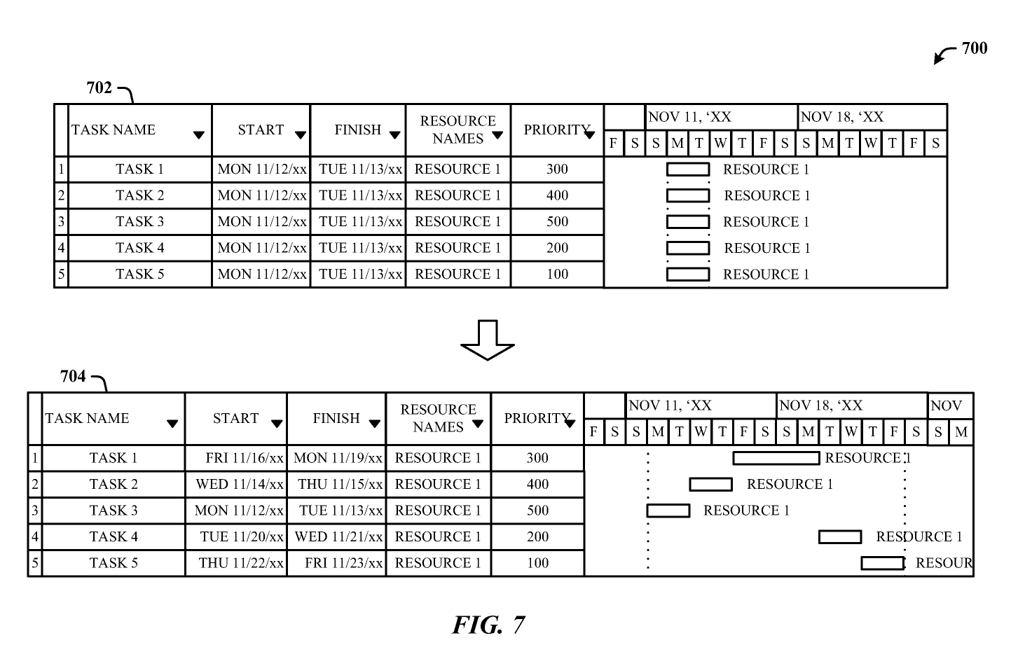

FIG. 7 illustrates the implementation of leveling order based on priority data. The leveling order functionality based on priority data is illustrated by way of resource panels 700. If tasks have a unique priority value, leveling will use the user-entered value to determine which tasks to delay first. More important tasks having larger priority values and are scheduled to happen before tasks with smaller priority values. A first resource panel 702 shows five tasks before leveling according to the leveling order. A second resource panel 704 shows the five tasks after leveling according to the leveling order where the task with the largest priority occurs first.

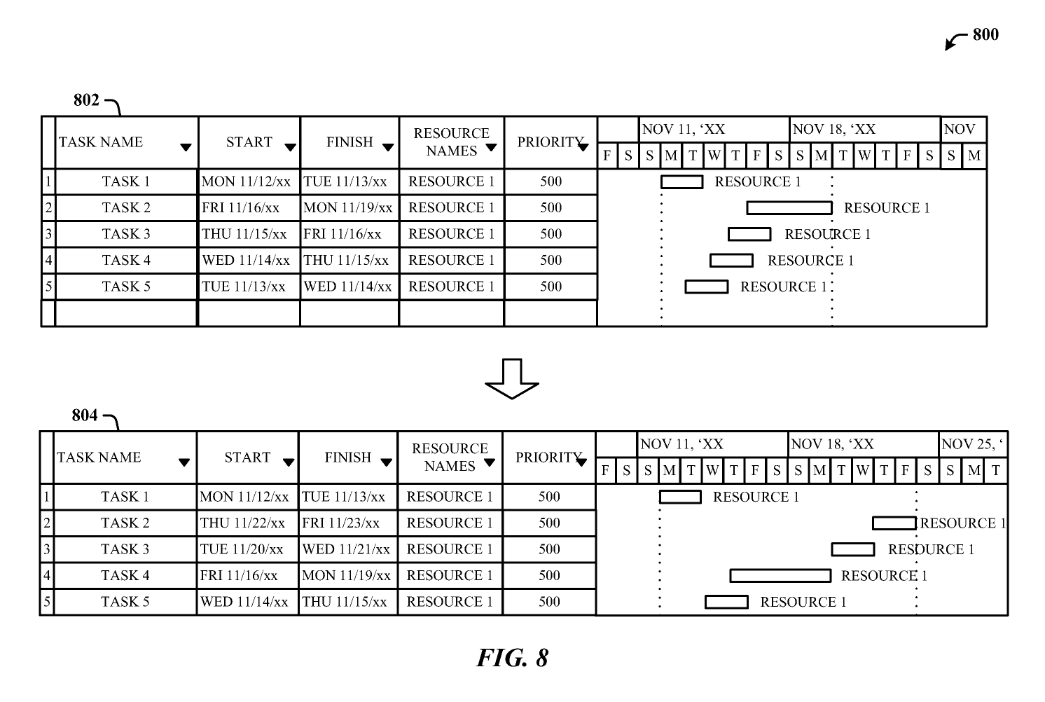

FIG. 8 illustrates the implementation of leveling order based on start date. The leveling order functionality based on start date is illustrated by way of resource panels 800. By default, if users do not define a priority value for a task, the task is automatically assigned a priority of 500. If tasks have the same priority value, the task start dates are used to determine the leveling order. A first resource panel 802 shows five tasks before leveling according to a leveling order that includes the start date (and equivalent priority values). A second resource panel 804 shows the five tasks after leveling according to the leveling order where the task with the earliest start date occurs first.

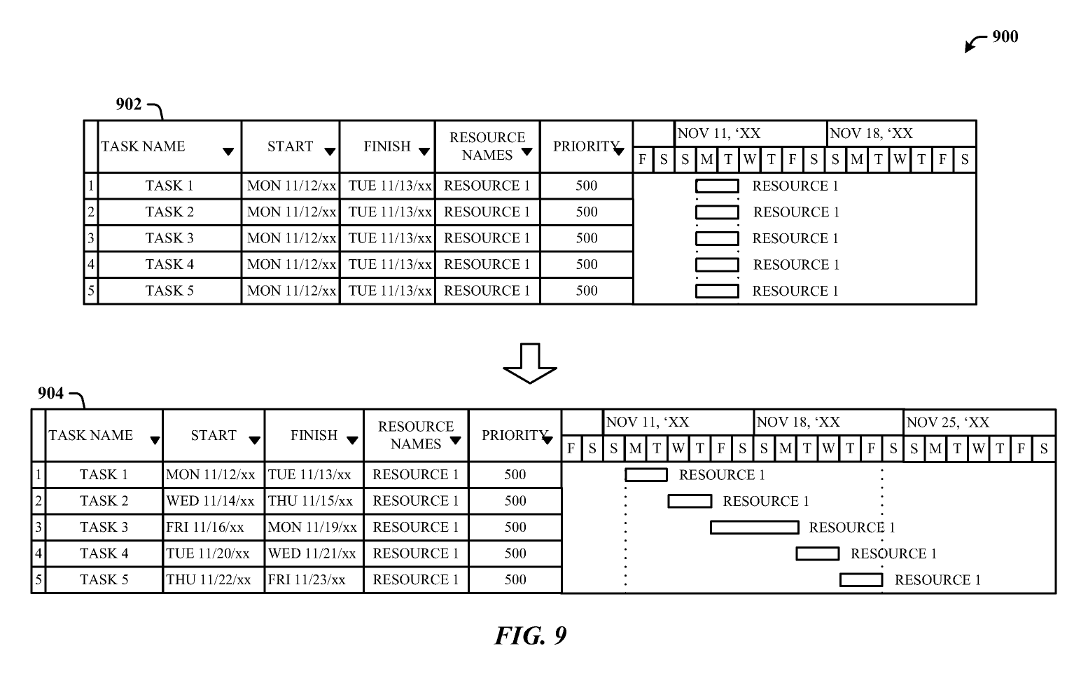

FIG. 9 illustrates the implementation of leveling order based on task ID. The leveling order functionality based on task ID is illustrated by way of resource panels 900. By default, if users do not define a priority value for a task, the task is automatically assigned a priority of 500. If tasks have the same priority value, the task start dates are used to determine the leveling order. If the priority data and start dates are the same, then leveling is based on the task IDs. A first resource panel 902 shows five tasks before leveling according to a leveling order that includes the same priority values and start dates. A second resource panel 904 shows the five tasks after leveling according to the leveling order where the task ID is used based on equivalent priorities and start dates. In FIG. 8 and FIG. 9, leveling by the algorithm can occur without assigning priority values to the tasks.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

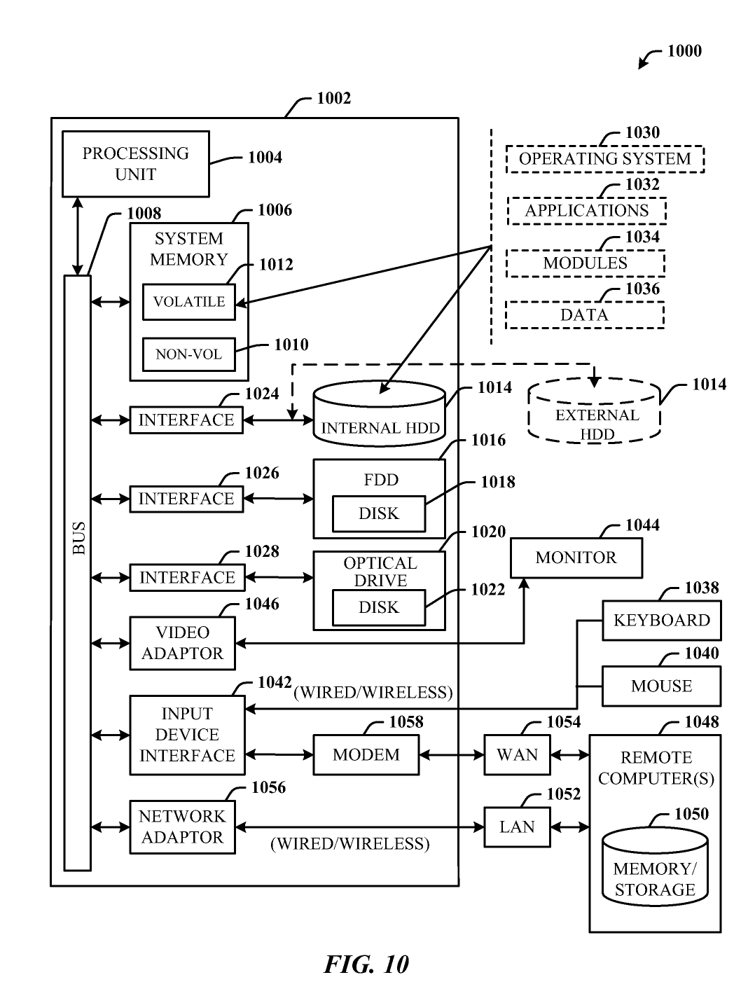

Referring now to FIG. 10, there is illustrated a block diagram of a computing system 1000 operable to execute resource allocations in accordance with the disclosed architecture. In order to provide additional context for various aspects thereof, FIG. 10 and the following discussion are intended to provide a brief, general description of a suitable computing system 1000 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 10, the exemplary computing system 1000 for implementing various aspects includes a computer 1002 having a processing unit 1004, a system memory 1006 and a system bus 1008. The system bus 1008 provides an interface for system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 can include non-volatile memory (NON-VOL) 1010 and/or volatile memory 1012 (e.g., random access memory (RAM)). A basic input/output system (BIOS) can be stored in the non-volatile memory 1010 (e.g., ROM, EPROM, EEPROM, etc.), which BIOS are the basic routines that help to transfer information between elements within the computer 1002, such as during start-up. The volatile memory 1012 can also include a high-speed RAM such as static RAM for caching data.

The computer 1002 further includes an internal hard disk drive (HDD) 1014 (e.g., EIDE, SATA), which internal HDD 1014 may also be configured for external use in a suitable chassis, a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as a DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1012, including an operating system 1030, one or more application programs 1032, other program modules 1034, and program data 1036. The one or more application programs 1032, other program modules 1034, and program data 1036 can include the tasks 102, resource 104, task properties (priority data, date information, task ID, etc. 106), scheduling component 108, definition component 202, leveling order 204, constraints 206, dependencies 208, project planning application 210, subset of tasks 212, user interface 214, example resource panels 300, 400, 700, 800, 900, and methods 500 and 600, for example.

All or portions of the operating system, applications, modules, and/or data can also be cached in the volatile memory 1012. It is to be appreciated that the disclosed architecture can be implemented with various commercially available operating systems or combinations of operating systems.

A user can enter commands and information into the computer 1002 through one or more wire/wireless input devices, for example, a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, etc.

A monitor 1044 or other type of display device is also connected to the system bus 1008 via an interface, such as a video adaptor 1046. In addition to the monitor 1044, a computer typically includes other peripheral output devices (not shown), such as speakers, printers, etc.

The computer 1002 may operate in a networked environment using logical connections via wire and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented resource leveling system, comprising:
a set of tasks assigned to an over-allocated resource for completion, each task associated with priority data, date information, and a task identifier; and
a scheduling component for rescheduling the tasks to the over-allocated resource based on one or more of the priority data, the date information, and the task identifier.

2. The system of claim 1, further comprising a definition component for defining a leveling order for which a task is rescheduled, the leveling order defined first according to the priority data, then optionally by the date information, and then optionally by the task identifier.

3. The system of claim 2, wherein the scheduling component reschedules the tasks based on the leveling order, while respecting constraints and dependencies.

4. The system of claim 1, wherein the scheduling component facilitates selection of a subset of the tasks for rescheduling and excludes unselected tasks from a resource availability calculation.

5. The system of claim 1, wherein the scheduling component reschedules a task assigned to the over-allocated resource without changing date information of other scheduled tasks.

6. The system of claim 1, wherein the scheduling component reschedules a task assigned to the over-allocated resource to a next available timeslot in which the over-allocated resource can work on the task.

7. The system of claim 6, wherein the scheduling component considers all tasks when searching for the next available timeslot for the task.

8. The system of claim 6, wherein the scheduling component reschedules the task independent of whether associated priority data is explicitly defined.

9. A computer-implemented resource leveling system, comprising:
tasks assigned to an over-allocated resource for completion, each task associated with priority data, date information, and a task identifier; and
a scheduling component for rescheduling the tasks to the over-allocated resource based on a leveling order defined according the priority data, the date information, and the task identifier, while respecting constraints and dependencies.

10. The system of claim 9, wherein the scheduling component facilitates selection of a subset of the tasks for rescheduling and excludes unselected tasks from the rescheduling of the subset.

11. The system of claim 9, wherein the scheduling component reschedules a task assigned to the over-allocated resource without changing start date information of other scheduled tasks.

12. The system of claim 9, wherein the scheduling component reschedules a task assigned to the over-allocated resource to a next available timeslot in which the over-allocated resource can work on the task, and selects the next available timeslot in consideration of all tasks.

13. The system of claim 9, further comprising a user interface for a project planning application that provides interaction with functionality of the scheduling component to reschedule to a next available timeslot and to level a selected set of the tasks.

14. A computer-implemented method of processing resources, comprising:
receiving a resource allocated to tasks, the tasks associated with priority data, start date information, and a task identifier; and
leveling the tasks based on the priority data and one or more of the start date information and a task identifier.

15. The method of claim 14, wherein the priority data, start date information and the task identifier are processed according to a leveling order.

16. The method of claim 14, further comprising processing constraints and dependencies as part of the leveling of the tasks.

17. The method of claim 14, further comprising scheduling a new task assigned to the resource in a next available timeslot.

18. The method of claim 17, further comprising processing all tasks when computing the next available timeslot.

19. The method of claim 14, wherein the tasks are a subset of a larger set of tasks allocated to the resource, the tasks selected and leveled without impacting a start date of unselected tasks of the larger set of tasks.

20. The method of claim 14, further comprising rescheduling the tasks bases on an ascending order of importance where less important tasks are delayed before more important tasks.
